(19) United States
(12) Patent Application Publication
(10) Pub. No.: US 2013/0139194 A1
(43) Pub. Date: May 30, 2013

(54) SYSTEMS AND METHODS TO DETERMINE EXPECTED VIEWERSHIP OF FUTURE TELEVISION BROADCASTS USING RECORDING TIMER DATA

(71) Applicant: Richard M. Carini, Gilroy, CA (US)

(72) Inventor: Richard M. Carini, Gilroy, CA (US)

(73) Assignee: SLING MEDIA, INC., Foster City, CA (US)

(21) Appl. No.: 13/307,913

(22) Filed: Nov. 30, 2011

(51) Int. Cl. H04N 21/258

(52) U.S. Cl. 725/14

(57) ABSTRACT

Systems, devices and methods are described to predict the viewership of a television broadcast before the broadcast occurs. Viewers select future broadcasts to record on a digital or other personal video recorder (DVR/PVR), or on any sort of remote storage video recorder (RSDVR). Data describing recordings selected by multiple viewers is provided to a data processing system that determines an expected program viewership based upon the received data.

### TECHNICAL FIELD

The following discussion generally relates to systems and techniques for processing information relating to television viewing. More particularly, the following discussion relates to systems and methods to predict the future popularity of a television program using recording timer data that is gathered from multiple viewers.

### BACKGROUND

Watching television continues to be a primary source of entertainment for people throughout the world. Typically, television viewers receive their programming via a cable, direct broadcast satellite (DBS) and/or terrestrial broadcast that allows for wide distribution of many different programs. In practice, however, it can be difficult for the broadcaster to accurately gauge the number of viewers of any particular broadcast program. It is even more difficult to accurately predict the number of viewers that will watch a future program that has not yet been broadcast. Since broadcasters typically receive a substantial portion of their revenue though sales of advertising contained within the broadcasts, it would be of value to have improved knowledge of how many viewers intend to watch various programs before the programs are actually broadcast.

Current techniques for gathering data about television viewership, however, are somewhat limited. Polling services can question viewers as to which programs they are viewing or have viewed, but polling can be cumbersome and expensive. Viewership reporting functions can be built into set top boxes or other television receivers, but these reports are typically limited to real-time or past viewing activity. While this information may be useful in predicting viewer habits and preferences, it is typically not timely or specific enough to benefit the broadcaster at the time of the actual broadcast.

It is therefore desirable to provide systems, devices and/or processes that are able to accurately predict future viewership of television programs. It would be further desirable that any such systems, devices or processes be reliable, unobtrusive to the viewer, and convenient to implement. These and other desirable features and characteristics will become apparent from the subsequent detailed description and the appended claims, taken in conjunction with the accompanying drawings and this background section.

### BRIEF SUMMARY

According to various exemplary embodiments, systems, devices and methods are described to determine expected viewership of future television broadcasts using recording timer data obtained from one or more recording devices.

In some exemplary embodiments, a method is executable by a computer server or other data processing system. The method suitably includes receiving, at the data processing system, data describing recording timers set by a plurality of viewers, wherein the recording timers describe future television broadcasts that the viewers intend to record. The data processing system aggregates the received data describing the recording timers to thereby determine an expected viewership of the future television broadcasts. An output is provided from the data processing system that is indicative of the predicted viewership.

In other exemplary embodiments, a computerized data processing system comprises a network interface to a digital network, a non-transitory data storage configured to store digital data in a computer-readable format, and a microprocessor or other digital controller. The digital controller is configured to receive, via the network interface, data describing recording timers set by a plurality of viewers that indicate future television broadcasts that the viewers intend to record, to store at least some of the received data in the data storage, to determine an expected viewership of at least one of the future television broadcasts based upon the received data, and to provide an output from the data processing system based upon the expected viewership.

Still other embodiments provide a method executable by a personal video recorder device such as a digital video recorder, a remote storage digital video recorder, or the like. The method suitably comprises receiving, at the personal video recorder device, an instruction that indicates a future television broadcast to record on the personal video recorder device. Prior to receiving the future television broadcast, data that identifies the future television broadcast from the personal video recorder device is provided to a remotely-located data processing system via a digital network. The future television broadcast is subsequently recorded at the personal video recorder device.

Additional embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a block diagram of an exemplary system for processing recording timer data from multiple viewers; and

FIG. 2 is a flowchart of an exemplary process for processing recording timer data.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

According to various embodiments, viewership of television programs can be effectively predicted by collecting and aggregating recording timer information from multiple viewers. Recording timer information is typically generated when a viewer directs a digital video recorder (DVR) or other personal video recorder (PVR) to record a particular program that has not yet been broadcast. Viewer interest in recording a program before it is actually broadcast is believed to strongly correlate with interest in watching the program itself, so recording instructions can provide a good predictor of future viewership. Further, the viewer's recording intentions may be available minutes, hours, days or even weeks before the program is actually broadcast. By receiving and aggregating recording timer data from multiple television viewers, interest in the programs can be reliably predicted even before the programs are actually broadcast.

Viewership information based upon recording timer data can be used for any purpose. In some embodiments, viewership predicted by the recording timer data can be used to adjust advertising rates for certain programs. If a broadcaster knows in advance that a substantial number of viewers have set recording timers for a particular program, for example, then advertising rates for that program may be adjusted as appropriate. In further embodiments, changes in viewer interest may be gauged over time. By tracking the changes in the numbers or the rates that recording timers are set, for example, the broadcaster can analyze how current events, marketing campaigns and/or other factors may affect interest in a television program even if the program itself has not yet been broadcast. Recording data therefore provides a useful predictor of actual interest in particular television programs even before the programs themselves are actually broadcast.

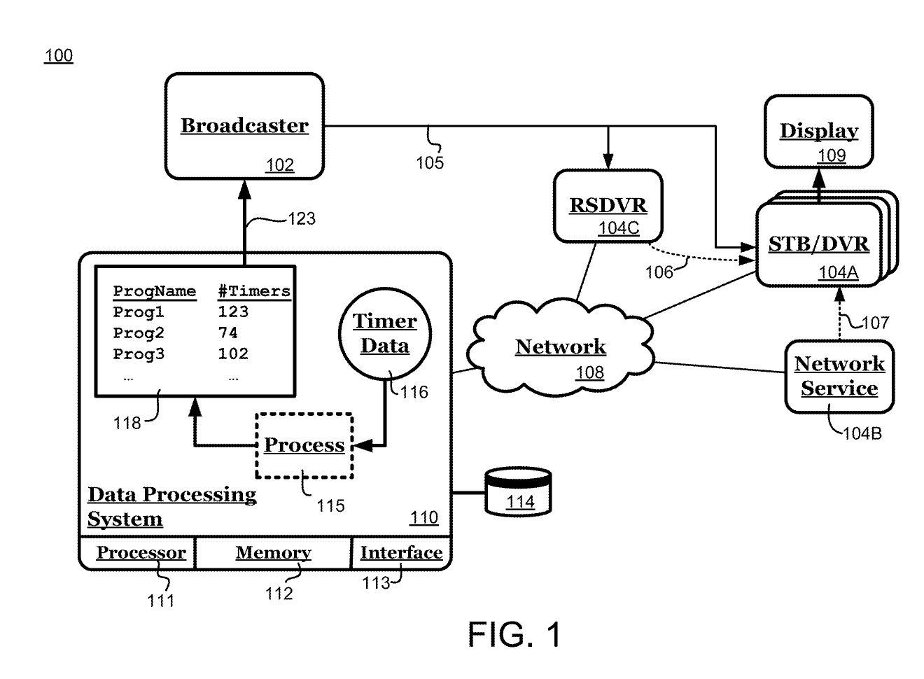

Many other aspects, embodiments and other features are described in increasing detail below. Turning now to the drawing figures and with initial reference to FIG. 1, an exemplary environment 100 suitably includes a data processing system 110 that receives recording timer data 116 from any number of client devices 104A-C. The recording timer data 116 generally describes one or more television programs that will be broadcast in the future by broadcaster 102 and that the viewer wishes to record on a PVR, DVR, RSDVR and/or other device.

Recording timer data 116 is provided to the data processing system no as appropriate. In some implementations, data 116 may be transmitted from one or more client devices 104A-C via the Internet or another network 108. The data processing system no suitably aggregates the recording timer data 116 from multiple viewers, and provides an aggregated output of information 118 that predicts or otherwise indicates viewer interest in the future broadcasts. This information 118 may be provided to the broadcaster 102, and/or used for any other desired purpose.

Data processing system no is any computing platform capable of receiving recording timer data from multiple viewers and providing an output that provides aggregated information 118 based upon the received recording timer data 116. In various embodiments, data processing system no is based upon any commercially-available computer server that includes conventional processing hardware such as a processor 111, memory 112 and interfaces 113 for network communication or other forms of input/output as appropriate. A database 114 or other storage resource may also be available to store data that is collected and/or processed by system no. Various embodiments of system 110 may be implemented using conventional computing hardware, such as conventional dedicated or shared hardware servers. Equivalent implementations may make use of one or more virtual server resources, such as any of the cloud computing services provided by AMAZON, GOOGLE, IBM, MICROSOFT, ORACLE, IBM, UBUNTU and/or any number of other providers. The Amazon Web Services (AWS) products and services available from Amazon.com, for example, could be used to implement some or all of processing system 110 in some embodiments, although other embodiments may use any other products or services as desired.

In many embodiments, data processing system no includes appropriate processing software 115 to perform the various functions described herein. Such software 115 may be stored in mass storage or other long term memory, and may be loaded into memory 112 for executing by processor 111, as appropriate. Software 115 may be formatted in any source or object code format for execution within any operating system or other processing environment.

Any number of different client devices 104A-C may be present to support any number of different viewers. In the embodiment shown in FIG. 1, client devices 104A-C represent any sorts of consumer devices, network servers, commercial recording services, or the like. Typically, when a viewer selects a future-broadcast program to record, the client device 104 generates a “timer” to trigger recording of the program at the time that the selected program is broadcast. This timer may be represented with data 116, which typically contains sufficient information to identify the program being recorded. Such information may include the program name, episode number, channel, time and date, or the like in some implementations. In other implementations, data 116 may simply include a code that uniquely identifies the program being recorded (e.g., an EPG or other program-identifying code). One example of a program-identifying code might include a code generated by Tribune Media Services (TMS) or another vendor of program guide data that uniquely identifies a program or episode of a program. Timer data 116 may be stored on the client device 104, in a server or cloud-based service available via network 108, and/or elsewhere as appropriate. Other embodiments may use different techniques for representing or storing recording timer data 116 as desired.

Environment 100 may include any number of different devices 104 to support any number of viewers. Device 104A in FIG. 1, for example, represents a conventional personal video recorder (PVR) or digital video recorder (DVR) operated by a particular viewer. Many conventional DVR devices 104A are currently available from any number of different sources. Some DVR-type devices 104A may be incorporated into a common set top box (STB) or similar device that also receives broadcast television signals using a direct broadcast satellite (DBS), cable or other television receiver. Set top boxes that incorporate DVR functionality are available from most DBS and cable broadcasters 102. Many different types of DVR, PVR, STB and other consumer devices 104A presently have interfaces to access to network 108, and many of these devices 104A could be readily enhanced (e.g., through software or firmware updates) to provide timer data 116 to data processing system no, as desired.

Some embodiments may alternately or additionally provide recording timer data 116 from one or more network services 104B that receive recording instructions from viewers via a web browser, mobile phone or other interface. A web-based service 104B, for example, could allow viewers to access an electronic program guide (EPG) showing upcoming television programs, and then allow viewers to select programs to record from the EPG. In some implementations, service 104B transmits instructions 107 based upon viewer inputs to DVRs, STBs or other recording devices 104A associated with the particular viewers to set recording timers on the particular devices 104A. In other embodiments, timer data 116 is maintained on the service 104B until such time as the program is broadcast, at which time service 104B directs a viewer's local device 104A or other recording device to record the program. Other implementations may store or otherwise process recording timer data 116 in any other manner, as desired.

Service 104B could be readily enhanced to share recording timer data 116 with a data processing system 110 for one or more viewers. Since many network services 104B are able to support relatively large numbers of viewers, such services may be a convenient single source of data 116 from many different viewers. Indeed, in some embodiments, network service 104B and data processing system no may be implemented within a common physical or logical server. To that end, a network service 104B that accepts viewer inputs and provides recording instructions 107 to particular recording devices 104A may be readily enhanced to output aggregate information about timer data 116 collected at service 104B, and/or to perform any other functions described with reference to system 110 herein.

Some embodiments may additionally or alternately provide one or more remote storage video recorders (RSDVRs), such as device 104C illustrated in FIG. 1. The RSDVR is typically a device or system that records broadcast programming at a centralized server for later retrieval by the viewer. In some implementations, programs recorded on an RSDVR 104C may be provided as a media stream 106 or the like to a STB 104A or other receiver that is located at the viewer's home, or that is otherwise in proximity to the display 109 used to view the present the programming to the viewer. Often, an RSDVR device 104C will record programs for multiple viewers, thereby providing a centralized resource for recording timer data 116. RSDVR device 104C may work in conjunction with a network service 104B in some implementations to allow viewers to set timers using an interface associated with service 104B that are then processed at device 104C, as desired. Other embodiments may combine a network service 104B and RSDVR device 104C into a common platform or server, as desired. As with the network service 104B described above, timer data 116 may be provided in the aggregate or otherwise to data processing system no. In still other embodiments, the functions described with respect to data processing system no may be incorporated into the RSDVR system 104C, as appropriate.

Network 108 is any sort of digital or other network that facilitates communications between client devices 104A-C and data processing system no. In various embodiments, network 108 represents the Internet or a similar network. Equivalent embodiments may incorporate networks 108 that use telephone protocols, corporate or private networks, wireless or wired networks, or any other networking features as appropriate.

In operation, then, any number of different viewers each select television programs to be recorded from future broadcasts 105 as appropriate. Recordings may be selected using a viewer's personal STB or DVR 104A, using a networked service 104B that communicates with the viewer's personal device 104A, using a RSDVR-type system that records programs for multiple viewers, or using any number of other devices 104. Each of these recordings is represented by recording timer data 116 that indicates the particular program selected by the viewer for future recording.

Recoding timer data 116 obtained from the various viewers and/or devices 104 is processed at system 110 as appropriate. The received data 116 may be stored (e.g., in database 116) and aggregated to provide an output 118 that is useful in predicting future viewership of broadcast programming. In various embodiments, a report 118 that aggregates and/or summarizes the timer data 116 collected from the various viewers is generated. Report 118 may provide, for example, a list of television programs that are to be broadcast in the future, along with a number of recording timers that have been observed for each particular program. This information represents one measure of an expected viewership for the program, since it represents a number of users who have manifested an interest in the particular program before the program is broadcast. Other information may be provided as appropriate, and as described more fully below.

The aggregated information 118 collected and processed by system no may be used for any purpose. In various embodiments, the information 118 could be automatically or otherwise provided 123 to broadcaster 102 to use in market research, adverting rate setting, or for any other purposes. As one example, a broadcaster 102 may adjust its advertising rates upwardly or downwardly if it observes increasing or decreasing interest in future programs. This adjusting of advertising rates may be automated in any manner within data processing system no and/or within any systems associated with broadcaster 102. Again, various embodiments may use the information 118 collected and processed by system no in any number of alternate but equivalent ways.

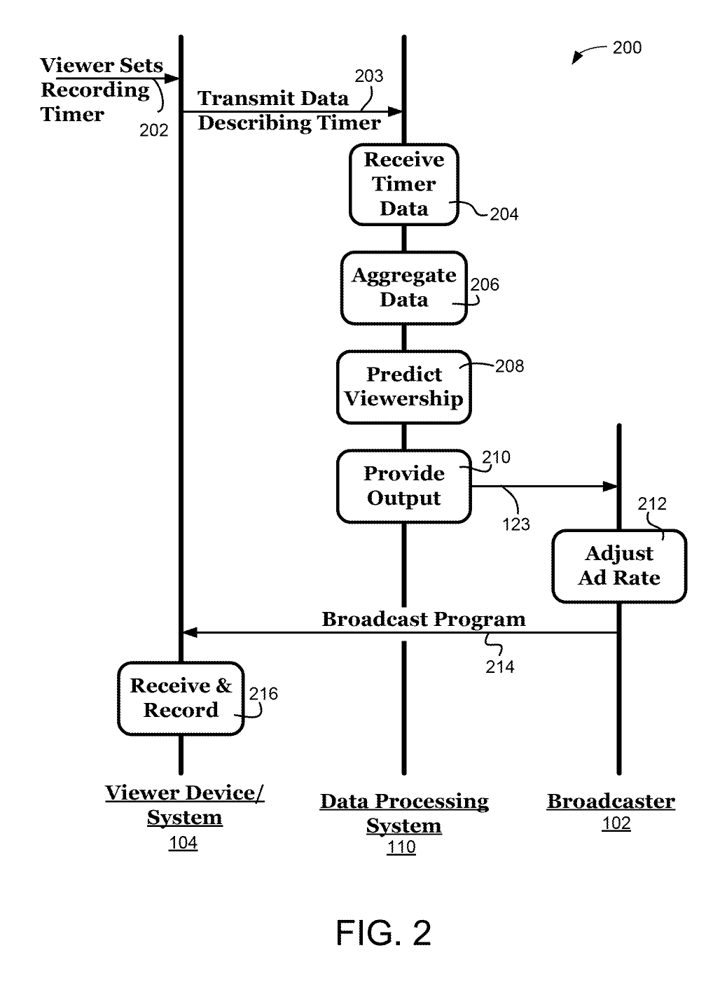

With reference now to FIG. 2, an exemplary process 200 to determine expected viewership of future television broadcasts using recording timer data 116 suitably includes the general functions of receiving viewer selections for programs to record at one or more viewer devices 104 (function 202), and providing recording timer data 116 to the data processing system 110 (function 203). The data processing system no suitably receives and stores the timer data 116 (function 204), aggregates the timer data 116 from multiple viewers (function 206), and provides an output 118 that represents the aggregated data (function 210). Various embodiments may perform additional processing to predict viewership or one or more programs (function 208), to adjust advertising rates (function 212), and/or to perform other functions as described more fully below.

As noted above, viewers may interact with any number of different devices 104 to select programs to record (function 202). Viewers may select programs using their own STBs or other DVR devices 104A, using network services 104B, using an RSDVR device 104C, and/or in any other manner. In various embodiments, the recording device 104 provides an EPG grid or other display that describes various programs that are available for recording during future broadcast. In such embodiments, the user typically selects programs to record from the grid using a graphical or other interface; other interfaces may be equivalently used in other embodiments. The viewer's instruction results in a recording timer being set at the recording device 104 that triggers the recording when the program is broadcast in the future. As noted above, timer data 116 may be stored in a local DVR or other recording device 104A. Data 116 could be equivalently stored “in the cloud” (e.g., on network service 104B or RSDVR 104C) as desired.

Recording timer data 116 is provided to the data processing system no in any manner (function 203). As noted above, various embodiments may transmit the timer data 116 from a DVR, STB, network service, RSDVR or other device 104 over network 108. Other embodiments may simply provide the data 116 to a separate data processing system no that resides as a function or service on a common computing platform as a network service 104B, RSDVR 104C, or the like. Timer data 116 may be provided in real time as the viewer selects programs to record in some embodiments. Other embodiments may equivalently provide timer data 116 for one or more timers in a batch mode using any temporal basis (e.g., daily, hourly, minutes) for delivery. Other embodiments may provide timer data 116 in response to polling from data processing system 110, or in any other manner.

The timer data 116 received for each of the various viewers and/or recording devices 104 is appropriately stored at data processing system no for further analysis (function 206). Timer data 116 may be stored in a relatively transient manner in memory 112 for short-term processing, as appropriate. Data 116 may be additionally or alternately stored in database 114 or elsewhere for subsequent processing in some embodiments.

The timer data 116 from multiple viewers is aggregated as appropriate (function 206) to generate a suitable output 118. In various embodiments, timer data 116 for various viewers is aggregated over an appropriate period of time, and output 118 is generated to describe the number of timers that are created for one or more future-broadcast programs. Data may be aggregated for a particular program, for multiple programs, or in any other manner. Various equivalent embodiments could aggregate data for particular channels or networks, for example, or for multiple episodes of the same television program. Again, data 118 may be sorted, indexed and/or otherwise organized in any manner.

Various embodiments further use the aggregated timer data 118 to predict the viewership of a program that will be broadcast in the future (function 208). The expected viewership may be predicted, for example, by counting the number of recording timers that have been set for the program and then using conventional linear or multi-order regression analysis to extrapolate or otherwise relate the data observed for the program to the expected viewership. Such an extrapolation technique may consider such factors as, for example, the number of timers set as a proportion to the total number of viewers providing data, past correlations of recording timer data to actual viewership for the particular program, channel, network, or the like. Other embodiments may use other techniques that consider alternate or additional factors as desired. Although FIG. 2 shows viewership prediction function 208 being performed by the data processing system 110, other embodiments may omit such predicting, and/or may perform the predicting function at another system (e.g., at a data processing system associated with broadcaster 102).

The aggregated data 118 is output from data processing system no in any manner (function 210). Various embodiments provide output data 118 as a data file that may be manually reviewed by a human or machine, whereas other embodiments could provide output 118 as a file that is sorted, summarized and/or otherwise further processed as desired. To that end, the output data 118 may be provided in any medium, such as on a display, over a network, in a data file stored in a memory or other non-transitory electronic storage, and/or in any other manner.

In the example shown in FIG. 2, output data 118 is provided 123 from data processing system no to the broadcaster 102. In various embodiments, the aggregated data 118 may allow broadcaster 102 to gauge interest in future broadcasts, and to adjust advertising rates (function 212) in response thereto. The adjustment may be performed manually in some embodiments, or automatically by a data processing system associated with broadcaster 102. Equivalent embodiments could perform the advertising rate adjustment function 212 at data processing system 110, as desired. In such embodiments, advertising rates may be provided as a network service using conventional techniques. Other embodiments may provide data 118 to any other recipient for use in accordance with any other purpose, as desired.

FIG. 2 also shows that the recording timer data 116 associated with the various viewers and programs is collected and aggregated before the programs are actually broadcast (function 214). This allows the data 116 to be useful to the broadcaster 102 or other parties in predicting the expected viewership in advance of actual broadcasts. When the program is actually broadcast (function 214), the viewer's DVR or other recording device 104 is able to receive and/or record the program (function 216).

Generally speaking, the various functions and features of method 200 may be automatically executed by any sort of hardware, software and/or firmware logic that is stored and/or executed on any platform. Some or all of method 200 may be carried out, for example, by programmed logic executing within data processing system 110 and/or client device 104 in FIG. 1. In one embodiment, processor 111 executes software logic 115 that performs each of the various functions associated with system 110 in FIG. 2. Such logic may be stored in memory 112 or in any other non-transitory storage available to processor 111 as desired. Client device 104 may similarly have a processor to execute software instructions that carry out the various functions shown to be associated with device 104 in FIG. 2. Such instructions may be stored in a memory or other non-transitory storage medium available to the client device 104 as desired. The particular logic and hardware that implements any of the various functions shown in FIG. 2 may vary from context to context, implementation to implementation, and embodiment to embodiment in accordance with the various features, scenarios and structures set forth herein. The particular means used to implement each of the various functions shown in FIG. 2, then, could be any sort of hardware processing structures that are capable of executing conventional software logic in any format. Such processing hardware may include processor 111 or other components of system 110, as well as any other processors or other components associated with any conventional DVRs, STBs, RSDVRs, network services, and/or other client devices 104 as appropriate.

The general systems, structures and techniques described above may be inter-combined, enhanced, modified and/or otherwise implemented to provide any number of different features. Although the preceding discussion focuses primarily on satellite, cable and terrestrial broadcast sources of television, for example, equivalent embodiments could apply the same features in any other context, including any sort video file delivery or streaming video format (e.g., streaming video over the Internet or another network), cinema format and/or the like.

The term “exemplary” is used herein to represent one example, instance or illustration that may have any number of alternates. Any implementation described herein as “exemplary” should not necessarily be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A method executable by a data processing system, the method comprising:
receiving, at the data processing system, data describing recording timers set by a plurality of viewers, wherein the recording timers describe future television broadcasts that the viewers intend to record;
aggregating, by the data processing system, the received data describing the recording timers to thereby determine an expected viewership of the future television broadcasts; and
providing an output from the data processing system based upon the predicted viewership.

2. The method of claim 1 wherein the aggregating comprises determining a number of the plurality of viewers who intend to record the at least one of the future television broadcasts.

3. The method of claim 1 wherein the aggregating comprises predicting the expected viewership of the future television broadcasts based upon the received data.

4. The method of claim 3 further comprising adjusting a cost of advertising to be presented during the at least one of the future television broadcasts based upon the expected viewership of the at least one of the future television broadcasts.

5. The method of claim 1 wherein the data describing the recording timers is received on a continuing basis, and wherein the method further comprises monitoring changes in the expected viewership over time.

6. The method of claim 5 further comprising adjusting a cost of advertising to be presented during the at least one of the future television broadcasts based upon the changes in the expected viewership of the at least one of the future television broadcasts.

7. The method of claim 1 wherein the data is received via a digital network from a plurality of personal video recorder devices each associated with one of the plurality of viewers.

8. The method of claim 1 wherein the data is received via a digital network from a network server that receives viewer inputs to select the future television broadcasts for recording and that directs personal video recorder devices associated with the viewers to record the future television broadcasts.

9. The method of claim 1 wherein the data for at least some of the plurality of viewers is received via a digital network from a remote storage digital video recorder.

10. A computerized data processing system comprising:
a network interface to a digital network;
a non-transitory data storage configured to store digital data in a computer-readable format; and
a digital controller configured to receive, via the network interface, data describing recording timers set by a plurality of viewers that indicate future television broadcasts that the viewers intend to record, to store at least some of the received data in the data storage, to determine an expected viewership of at least one of the future television broadcasts based upon the received data, and to provide an output from the data processing system based upon the expected viewership.

11. The data processing system of claim 10 wherein the data is received via the digital network from a plurality of personal video recorder devices each associated with one of the plurality of viewers.

12. The data processing system of claim 11 wherein at least some of the personal video recorder devices are set top boxes that also receive the television broadcasts.

13. The data processing system of claim 10 wherein the data is received via the digital network from a network server that receives viewer inputs to select the future television broadcasts for recording and that directs personal video recorder devices associated with the viewers to record the future television broadcasts.

14. The data processing system of claim 10 wherein the data for at least some of the plurality of viewers is received via a digital network from a remote storage digital video recorder.

15. The data processing system of claim 10 wherein the determining performed by the digital controller comprises predicting a number of the plurality of viewers who intend to watch the at least one of the future television broadcasts.

16. The data processing system of claim 15 wherein the digital controller is further configured to adjust a cost of advertising to be presented during the at least one of the future television broadcasts based upon the predicted viewership of the at least one of the future television broadcasts.

17. The data processing system of claim 10 wherein the data describing the recording timers is received on a continuing basis, and wherein the digital controller is further configured to monitor changes in the expected viewership over time.

18. The data processing system of claim 17 further wherein the digital controller is further configured to adjust a cost of advertising to be presented during the at least one of the future television broadcasts based upon the changes in the expected viewership of the at least one of the future television broadcasts.

19. A method executable by a personal video recorder device, the method comprising:
receiving, at the personal video recorder device, an instruction that indicates a future television broadcast to record on the personal video recorder device;
prior to receiving the future television broadcast, providing data that identifies the future television broadcast from the personal video recorder device to a remotely-located data processing system via a digital network; and
recording the future television broadcast at the personal video recorder device.

20. The method of claim 19 wherein the providing allows the data processing system to determine an expected viewership of the future television broadcast based upon the data and additional data received from other viewers

21. The method of claim 19 further comprising:
presenting an electronic program guide to the viewer that describes a plurality of future television broadcasts, and wherein the viewer indicates the future television broadcast to record from the electronic program guide; and
demodulating the future television broadcast from a broadcast television signal.
